(19) United States
(12) Patent Application Publication
(10) Pub. No.: US 2026/0294163 A1
(43) Pub. Date: Oct. 1, 2026

(54) BEVERAGE PREPARATION MACHINE WITH RELIABLE DISPENSING

(71) Applicant: SOCIÉTÉ DES PRODUITS NESTLÉ S.A., Vevey (CH)

(72) Inventors: Kentaro MIWA, Pully (CH); Sandro ZINGG, Rosshäusern (CH)

(21) Appl. No.: 19/489,396

(22) PCT Filed: Jun. 4, 2024
(86) PCT No.: PCT/EP2024/065283

§ 371 Date: Dec. 2, 2025

(30) Foreign Application Priority Data
Jun. 5, 2023 (EP) 23177183.3

(51) Int. Cl. A47J 31/46

(52) U.S. Cl. CPC A47J 31/469

(57) ABSTRACT

A machine (1) for dispensing a beverage (100) has a beverage processing unit (5) and a beverage outlet (10) in fluid communication with the unit (5). The outlet (10) includes an outlet conduit (11) extending along a flow direction (12) and having a lower conduit part (11a) with a bottom end (13). A bottom dispensing opening (14) is located at the bottom end (13) to dispense beverage (100) from the bottom end (13) to an area (2) for placing a user-recipient (9). Above its bottom end (13), the lower conduit part (11a) has a single lateral dispensing opening (14a) that is configured to dispense beverage (100) above the bottom opening (14) from the lower conduit part (11a) to the placement area (2) when the bottom opening (14) is partly or fully obstructed at the bottom end (13).

### FIELD OF THE INVENTION

The field of the invention pertains to beverage preparation machines, in particular but not exclusively using capsules of an ingredient of the beverage to be prepared, having an arrangement managing the dispensing of beverage to a user-receptacle.

For the purpose of the present description, a “beverage” is meant to include any human-consumable liquid substance, such as tea, coffee, hot or cold chocolate, milk, soup, baby food, etc . . . A “capsule” is meant to include any pre-portioned beverage ingredient, such as 10 flavouring ingredient, within an enclosing packaging of any material, in particular an airtight packaging, e.g. plastic, aluminium, recyclable and/or biodegradable packagings, and of any shape and structure, including soft pods or rigid cartridges containing the ingredient. The capsule may contain an amount of ingredient for preparing a single beverage serving or a plurality of beverage servings.

### BACKGROUND ART

Certain beverage preparation machines use capsules containing ingredients to be extracted or to be dissolved; for other machines, the ingredients are stored and dosed automatically in the machine or else are added at the time of preparation of the drink.

Most beverage machines possess within a housing: filling means that include a pump for liquid, usually water, which pumps the liquid from a source of water that is cold or indeed heated through heating means, such as a heating resistor, a boiler, a thermoblock or the like, a brewing unit in which an ingredient is brewed with water or a mixing unit in which ingredients are mixed together, and a beverage outlet for dispensing the prepared beverage. Typically, the beverage outlet is located above a beverage dispensing zone, e.g. above a grid for supporting a cup or other recipient under the outlet and the passage of drops of liquid from the beverage outlet or other spills into a collector tray located under the grid.

There is a large variety of beverage preparations, in particular coffee preparation, with correspondingly dedicated preparation systems. The flavouring ingredient may be supplied to the machine within a capsule or loosely or as an agglomerate or in bulk, e.g. supplied as a particulate ingredient.

For the preparation of coffee it is known to use agglomerated roast and ground coffee portions, e.g. in the shape of balls, that are fed unpackaged to the machine. Examples of such systems are disclosed in WO 2022/018245, WO 2022/018249 and WO 2022/063801

Especially in the field of coffee preparation, machines have been widely developed in which a capsule containing beverage ingredients is inserted in a brewing device. The brewing device is tightly closed about the capsule, water is injected at the first face of the capsule, the beverage is produced in the closed volume of the capsule and a brewed beverage can be drained from a second face of the capsule and collected into a receptacle such as a cup or glass. Examples of such Systems are disclosed in WO 2005/004683, WO 2014/076041 and WO 2013/026845.

The preparation of a beverage by using centrifugation is also known. Such beverage preparation includes: providing a beverage (flavoring) ingredient, e.g. as powder and/or leaves; mixing it with liquid and rotating the mixture at sufficient speed to ensure interaction of the liquid with the ingredient while creating a gradient of pressure in the mixture. Such pressure increases gradually from the center towards the periphery of the centrifuged mixture. As liquid traverses the ingredient, e.g. coffee bed, extraction of the ingredient, e.g. coffee compounds, takes place and a liquid extract is obtained that flows out and is collected at the periphery. Examples of such systems are disclosed in WO 2008/148601, WO 2013/007776, WO 2013/007779 and WO 2013/007780.

WO 2006/050769, WO 2012/072758, WO 2013/127907, WO 2016/050657, WO 2016/083485, WO 2018/069266, WO 2019/121593, WO 2019/121594 and WO 2019/121865 disclose various beverage machines having a beverage outlet located downstream an ingredient processing unit configured to manage the beverage dispensing.

There is still a need to provide a management system of beverages such that the beverage is reliably dispensed to outside a beverage preparation machine.

### SUMMARY OF THE INVENTION

The invention relates to a machine for dispensing a beverage. The beverage preparation machine can be an in-home or out of home machine. The machine may be for the preparation of coffee, tea, chocolate, cacao, milk, soup, baby food, etc . . . .

The machine of the invention comprises a beverage processing unit and a beverage outlet in fluid communication with the unit.

The machine may be arranged for preparing within a beverage preparation unit a beverage by passing hot or cold water or another liquid through a flavoring ingredient supplied into the unit for example within a capsule or loosely or as an agglomerate or in bulk, e.g. supplied as a particulate ingredient. The flavoring ingredient of the beverage to be prepared may be selected from ground coffee or tea or chocolate or cacao or milk powder.

The beverage preparation typically includes the mixing of a plurality of beverage ingredients, e.g. water and milk powder, and/or the infusion of a beverage ingredient, such as an infusion of ground coffee or tea with water. One or more of such ingredients may be supplied in loose and/or agglomerate powder form and/or in liquid form, in particular in a concentrate form. A carrier or diluent liquid, e.g. water, may be mixed with such ingredient to form the beverage. Typically, a predetermined amount of beverage is formed and dispensed on user-request, which corresponds to a serving. The volume of such a serving may be in the range of 25 to 200 ml and even up to 400 or 1000 ml, e.g. the volume for filling a cup or a mug, depending on the type of beverage. Formed and dispensed beverages may be selected from ristrettos, espressos, lungos, cappuccinos, latte macchiato, café latte, americano coffees, teas, etc . . . In particular, a coffee machine may be configured for dispensing espressos, e.g. an adjustable volume of 20 to 60 ml per serving, and/or for dispensing lungos, e.g. a volume in the range of 70 to 150 ml per serving, and/or for dispensing americanos, e.g. a volume in the range of 150 to 500 ml.

The beverage outlet of the machine includes an outlet conduit extending along a flow direction and having a lower conduit part with a bottom end. A bottom dispensing opening is located at the bottom end to dispense beverage from the bottom end to an area for placing a user-recipient, e.g. a cup or a mug, to collect such dispensed beverage.

The user-recipient placing area can be delimited by a receptacle support. Typically the support includes a support surface for positioning a user-recipient, e.g. a mug or a cup, to collect the dispensed beverage. The support surface may be formed by a support member that is part of the machine or may be a virtual surface, e.g. the surface of a table on which the machine is placed. Examples of such support surfaces for user-recipients are disclosed in EP 1 867 260, WO 2009/074557 and WO 2013/104636.

Typically, the beverage outlet and/or the processing unit is located at least partly in a stationary frame and/or housing. The stationary frame and/or housing may be used for assembling the machine's components therein, e.g. the components mentioned below. Exemplary beverage preparation architectures are for instance disclosed in WO 2009/074550 and WO 2009/130099.

The beverage outlet may be movable relative to the stationary frame and/or housing between a dispensing position in which the beverage outlet dispenses via the lower conduit part such beverage to the area for placing a user-recipient and a non-dispensing position in which the beverage outlet prevents dispensing via the lower conduit part to such area, e.g. the beverage outlet directing waste liquid towards a waste collector. Examples of such beverage outlets with dispensing and non-dispensing positions are disclosed in the references cited in the background art description above.

The waste collector may include a removable receptacle, e.g. located with a machine's frame such as a machine housing. Examples of such collectors are disclosed in EP 1 867 260, WO 2009/074557, WO 2009/074559, WO 2009/135869, WO 2011/086087 and WO 2011/154492. Typically, the waste collector is configured for collecting at least one of: one or more waste beverage ingredients, such as a used flavouring ingredient and/or waste water; one or more used capsules for supplying a beverage ingredient into the machine; and a cleaning agent, such as a cleaning, rinsing or descaling liquid.

The processing unit may have a first part and a second part that are relatively movable between a proximate configuration in which they delimit a chamber for containing and processing a beverage ingredient therein and a distant configuration for receiving in the chamber and/or evacuating from the chamber such ingredient. Examples of such processing units are disclosed in the references cited in the background art description above.

Above its bottom end, the lower conduit part has a single lateral dispensing opening that is configured to dispense beverage above the bottom opening from the lower conduit part to the area for placing a user-recipient when the bottom opening is partly or fully obstructed at the bottom end.

Hence, when the bottom opening is partly or fully obstructed, e.g. clogged, beverage may still flow out via the lateral dispensing opening. As there is only a single lateral dispensing opening that is configured to dispense beverage to the area for placing a user-recipient, the flow of beverage is less likely to be laterally split into a shower out of the beverage outlet but rather maintained as one or possibly two streams.

The beverage guide may further incorporate different flow managing elements, e.g. as disclosed in WO 2018/069268 and WO 2019/121593.

The single lateral dispensing opening may extend, e.g. substantially upstream, from the bottom opening, e.g. forming a continuous beverage passage therewith.

The single lateral dispensing opening can form an elongated opening extending along the flow direction. In such a configuration, an obstructed bottom opening is still exposed to outflowing beverage when the beverage flows out of the lateral dispensing opening which may favour un-obstructing the bottom opening.

The single lateral dispensing opening may form an opening that extends sideways about a central axis of the lower conduit part over an angle of less than 180 deg., such in the range of 5 to 165 deg., for instance in the range of 15 to 150 deg., for example in the range of 45 to 135 deg., e.g. in the range of 60 to 120 deg. or 75 to 105 deg. The central axis can be parallel or colinear with the flow direction.

The lateral dispensing opening may have a total outflow surface area that is greater than 50% of a total outflow surface area of the bottom opening, typically in the range of 60 to 300% of the total outflow surface area of the bottom opening, optionally in the range of 75 to 200% thereof, such as in the range of 85 to 150% thereof, e.g. in the range of 90 to 125% thereof.

The lower conduit part can be associated with an inner flow guide.

The inner flow guide may extend above the bottom end inside the conduit bottom part and optionally thereabove, for instance in parallel to the flow direction.

The inner flow guide may extend below the bottom end outside the conduit bottom part, for instance in parallel to the flow direction.

The inner flow guide may include one or more guide members that extend across at least part of the bottom end, the single lateral dispensing opening having for example one side or two opposite sides delimited by such guide member(s).

The guide member(s) can be shaped substantially as ribs or bars or upright walls.

The guide members may be connected at a central part of the bottom end. The guide members can be connected to a central guide pin extending downstream the guide members or the beverage outlet being free of such pin.

One or more guide members may be spaced apart from a central part of the bottom end. The guide members can be spaced apart from a central guide pin extending downstream the guide members or the beverage outlet can be free of such pin.

One or more guide members may extend substantially radially relative to a or then above central axis of the lower conduit part.

The beverage processing unit may have a beverage guide and a guide outflow opening via which beverage is passed to the beverage outlet from the beverage guide. The beverage outlet can have:
a flow cavity delimited by a bottom and sidewall(s), optionally the beverage outlet being configured to accumulate a pool of beverage in the flow cavity; and
an inflow penetrator, such as an inflow-exposed protuberance, for penetrating a flow of beverage delivered by the unit outflow opening onto the penetrator prior to reaching the bottom of the flow cavity.

The inflow penetrator may have an upright generally spear-shaped member, such as a member with a cross section that has the shape of a cross or star or circle or convex polygon.

The inflow penetrator can comprise a top, such as a tapered top, that extends into the unit outflow opening, e.g. over a length in the range of 0.01 to 7 mm such as 0.3 to 3 mm, or that is spaced under the unit outflow opening by a distance in the range of 0.01 to 5 mm such as 0.3 to 3 mm.

The inflow penetrator may have a tapered top, e.g. a tapered top extending over a length in the range of 1 to 7 mm such as 2 to 5 mm, that extends from a cylindrical or prismatic penetrator bottom, e.g. a bottom extending over a length in the range of 1 to 15 mm such as 3 to 7 mm. For instance, the penetrator bottom and the tapered top having a length ratio in the range of 1.5 to 7 such as 2 to 5, e.g. 2.5 to 4.

The beverage processing unit may be configured to supply to the beverage outlet a beverage, e.g. coffee typically prepared by centrifugation or pressure extraction, that comprises at least one of foam, crema, a sweetener and oil. Pressure extraction typically occurs at a pressure in the range of 3 to 25 bar, e.g. in the range of 10 to 20 bar.

The beverage processing unit can be configured to be fed with a liquid, e.g. water, supplied via a machine fluid line from a liquid source, e.g. a machine tank or connector to an external liquid supply line, for instance via a machine pump and/or a thermal conditioner, e.g. a heater and/or cooler.

Such a pump may be used for driving a liquid, e.g. water, along a liquid line from the liquid source via the processing unit. Examples of pumps in beverage machines are disclosed in WO 2006/005425, WO 2009/024500, WO 2009/150030, WO 2010/108700 and WO 2011/107574,

Liquid may thus be driven in or into the processing unit via a thermal conditioner such as a heater and/or a cooler. A suitable heater may be a boiler, a thermoblock or an on demand heater (ODH), for instance an ODH disclosed in EP 1 253 844, EP 1 380 243 and EP 1 809 151. Other heaters are disclosed in WO 2009/043851, WO 2009/043865, WO 2009/092746 and WO 2011/157675 and WO 2012/007260.

The beverage processing unit may be configured to be fed with a flavouring ingredient, e.g. supplied into the beverage processing unit optionally within a capsule or loosely or as an agglomerate or in bulk, e.g. supplied as a particulate ingredient.

In an embodiment, the ingredient is supplied within such a capsule to the beverage preparation unit. The capsule may have a container covered by a lid e.g. a container and/or a lid extending radially to form a flange.

The capsule may have a body that is symmetric or asymmetric, conical or frusto-conical or cylindrical or spherical or hemispherical or frusto-spherical, containing the ingredient, e.g. ground coffee, tea or cacao or another beverage ingredient.

The capsule may be of the type described above under the header “field of the invention”. The capsule may be a capsule that has a container-body, e.g. a generally cup-shaped or hemispherical or hemi-ellipsoidal body, having a flange to which a cover lid (or membrane) is attached, in particular sealed. Typically the capsule contains a beverage ingredient. Examples of suitable capsules are disclosed in WO 2008/148601, WO 2008/148604, WO 2008/148646, WO 2008/148650, WO 2008/148656, WO 2008/148834, WO 2011/141532, WO 2011/141535, WO 2013/072239, WO 2013/072297, WO 2013/072326, WO 2015/044400. The capsule may be of the variety commercialised by Nespresso under the brand “Vertuo Line”, “Original Line” or “Professional Line”.

Examples of ingredient processing units are described in WO 2007/135135, WO 2009/043630, WO 2011/042400, WO 2014/096122 and WO 2014/096123.

The processing unit can be configured to process a capsule containing the beverage ingredient. The unit can have an ingredient chamber with at least one capsule opener, such as at least one of: one or more puncturing and/or tearing elements; and one or more pins and/or blades, such as a capsule piercer or tearing plate, e.g. as known from EP 0 512 468, EP 0 512 470, EP 1 299 022, EP 1 339 305, WO 2013/026845, WO 2014/076041, WO 2015/022342, WO 2015/022344 and WO 2015/022345.

The machine may include a control unit for controlling at least one of the motor (when present) and electric machine components, such as a liquid driver, thermal conditioner, a user-interface. Examples of control units and user-interfaces are disclosed in WO 2008/138710, WO 2009/043851, WO 2009/043865, WO 2009/092745, WO 2010/003932, WO 2010/037806, WO 2010/046442, WO 2011/020779, WO 2011/026853, WO 2011/054889, WO 2011/067156, WO 2011/067157, WO 2011/067181, WO 2011/067188, WO 2011/067191, WO 2011/067227, WO 2011/067232, WO 2011/144719, WO 2012/032019, WO 2012/072761, WO 2012/072764, WO 2012/072767 and WO 2012/093107.

When reference is made in the present description to an orientation or position relative to the machine or parts thereof, e.g. “above” or “below” or “vertical” or “horizontal”, the orientation or position takes as a reference the position and orientation of the machine in operation to process the liquid food substance in the food cavity unless specified otherwise.

### BRIEF DESCRIPTION OF THE DRAWINGS

The invention will now be described with reference to the schematic drawings, wherein:

FIG. 1 illustrates a beverage preparation machine according to the invention during beverage processing with a lower housing that contains part of a beverage processing unit and a beverage outlet, part of the housing being hidden to show the beverage outlet in the housing;

FIG. 2 shows the beverage preparation machine illustrated in FIG. 1 when the beverage processing unit has a first and second part in the distant configuration;

FIG. 3 shows an enlarged view from below of part of the housing and beverage outlet of the machine illustrated in FIG. 1, no beverage being dispensed out of the beverage outlet in FIG. 3;

FIG. 4 is a cross-section of the housing and beverage outlet shown in FIG. 3;

FIGS. 5 and 6 illustrate schematically from underneath two alternative embodiments of a bottom end and bottom dispensing opening of the beverage outlet; and

FIG. 7 is an enlarged view of part of the beverage outlet's lower part with the bottom end and beverage bottom dispensing opening shown in FIG. 3.

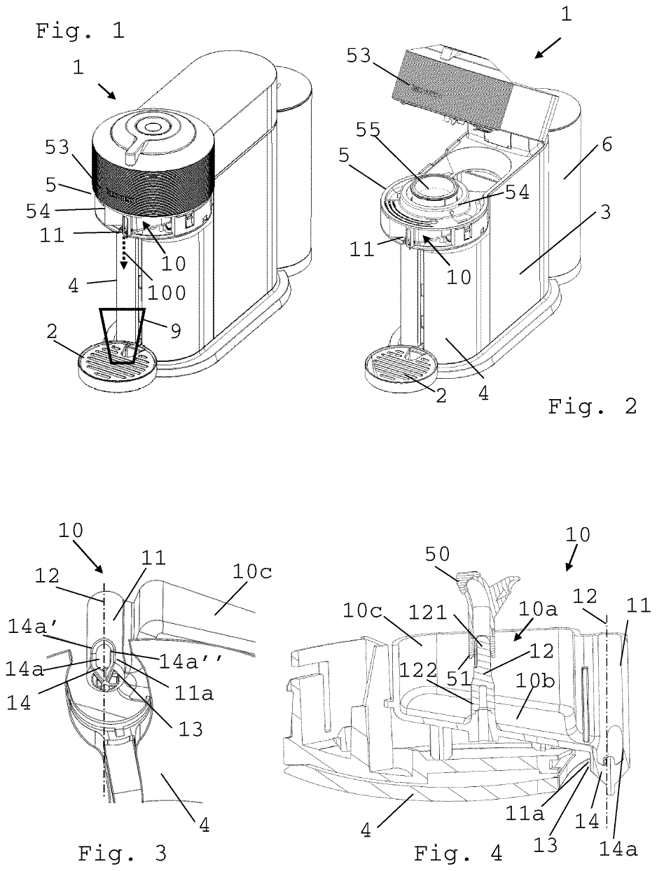

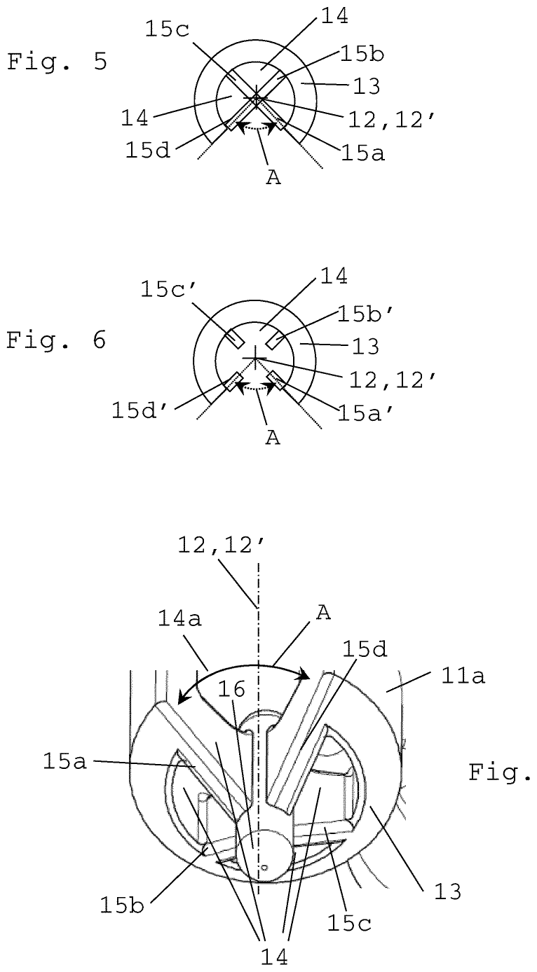

### DETAILED DESCRIPTION

The following description in connection with the appended figures illustrates a non-limiting embodiment and variations thereof of a machine 1 according to the invention.

Machine 1 is configured for dispensing a beverage 100. Machine 1 comprises a beverage processing unit 5 and a beverage outlet 10 in fluid communication with unit 5. Outlet 10 includes an outlet conduit 11 extending along a flow direction 12 and having a lower conduit part 11a with a bottom end 13. A bottom dispensing opening 14 is located at bottom end 13 to dispense beverage 100 from bottom end 13 to an area 2 for placing a user-recipient 9, e.g. a cup or a mug, to collect such dispensed beverage 100.

Beverage outlet 10 and/or processing unit (5) may be located at least partly in a stationary frame and/or housing 4.

Beverage outlet 10 can be movable relative to stationary frame and/or housing 4 between a dispensing position in which beverage outlet 10 dispenses via lower conduit part 11a beverage 100 to area 2 and a non-dispensing position in which beverage outlet 10 prevents dispensing via lower conduit part 11a to area 2, e.g. beverage outlet 10 directing waste liquid towards a waste collector 3.

Processing unit 5 may have a first part 53 and a second part 54 that are relatively movable between a proximate configuration in which they delimit a chamber 55 for containing and processing a beverage ingredient therein and a distant configuration for receiving in chamber 55 and/or evacuating therefrom such ingredient.

Above its bottom end 13, lower conduit part 11a has a single lateral dispensing opening 14a that is configured to dispense beverage 100 above bottom opening 14 from lower conduit part 11a to area 2 for placing a user-recipient 9 when bottom opening 14 is partly or fully obstructed at bottom end 13.

Single lateral dispensing opening 14a may extend, e.g. substantially upstream, from bottom opening 14, e.g. forming a continuous beverage passage 14,14a therewith.

Single lateral dispensing opening 14a can form an elongated opening extending along flow direction 12.

Single lateral dispensing opening 14a may form an opening that extends sideways about a central axis 12′ of lower conduit part 11a over an angle A of less than 180 deg., such in the range of 5 to 165 deg., for instance in the range of 15 to 150 deg., for example in the range of 45 to 135 deg., e.g. in the range of 60 to 120 deg. or 75 to 105 deg. Central axis 12′ can be parallel or colinear with flow direction 12.

Lateral dispensing opening 14a may have a total outflow surface area that is greater than 50% of a total outflow surface area of bottom opening 14, typically in the range of 50 to 300% of the total outflow surface area of bottom opening 14, optionally in the range of 75 to 200% thereof, such as in the range of 85 to 150% thereof, e.g. in the range of 90 to 125% thereof.

Lower conduit part 11a can be associated with an inner flow guide 15a,15a′,15b,15b′,15c,15c′,15d,15d′.

Inner flow guide 15a,15a′,15b,15b′,15c,15c′,15d,15d′ may extend above bottom end 13 inside conduit bottom part 11a and optionally thereabove, for instance in parallel to the flow direction.

Inner flow guide 15a,15a′,15b,15b′,15c,15c′,15d,15d′ can extend below bottom end 13 outside conduit bottom part 11a, for instance in parallel to the flow direction.

Inner flow guide may include one or more guide members 15a,15a′,15b,15b′,15c,15c′,15d,15d′ that extend across at least part of bottom end 13, optionally the single lateral dispensing opening 14a having one side or two opposite sides delimited by such guide member(s) 15a,15a′,15d,15d′.

Guide member(s) 15a,15a′,15b,15b′,15c,15c′,15d,15d′ can be shaped substantially as ribs or bars or upright walls.

Guide members 15a,15b,15c,15d can be connected at a central part of bottom end 13. Guide members 15a,15b,15c,15d may be connected to a central guide pin 16 extending downstream guide members 15a,15b,15c,15d or beverage outlet 10 may be free of such pin.

One or more guide members 15a′,15b′,15c′,15d′ can be spaced apart from a central part of bottom end 13. The guide members may be spaced apart from a central guide pin extending downstream the guide members or beverage outlet 10 is free of such pin.

One or more guide members 15a,15a′,15b,15b′,15c, 15c′,15d,15d′ may extend substantially radially relative to a or the abovemented central axis 12′ of lower conduit part 11a.

Beverage processing unit 5 can have a beverage guide 50 and a guide outflow opening 51 via which beverage 100 is passed to beverage outlet 10 from beverage guide 50. Beverage outlet 10 can have:
a flow cavity 10a delimited by a bottom 10b and (a) sidewall(s) 10c, optionally beverage outlet 10 being configured to accumulate a pool of beverage 100 in the flow cavity 10a; and
an inflow penetrator 12, such as an inflow-exposed protuberance 12, for penetrating a flow of beverage 100 delivered by unit Outflow opening 51 onto penetrator 12 prior to reaching bottom 10b of flow cavity 10a.

Inflow penetrator 12 may have an upright generally spear-shaped member, such as a member having a cross section that has the shape of a cross or star or circle or convex polygon.

Inflow penetrator 12 can have a top 121, such as a tapered top, that extends into unit outflow opening 51, e.g. over a length in the range of 0.01 to 7 mm such as 0.3 to 3 mm, or that is spaced under unit outflow opening 51 by a distance in the range of 0.01 to 5 mm such as 0.3 to 3 mm.

Inflow penetrator 12 may have a tapered top 121, e.g. a tapered top extending over a length in the range of 1 to 7 mm such as 2 to 5 mm, that extends from a cylindrical or prismatic penetrator bottom 122, e.g. a bottom extending over a length in the range of 1 to 15 mm such as 3 to 7 mm. Penetrator bottom 122 and tapered top 121 can have a length ratio in the range of 1.5 to 7 such as 2 to 5, e.g. 2.5 to 4.

Beverage processing unit 5 may be configured to supply to beverage outlet 10 a beverage, e.g. coffee typically prepared by centrifugation or pressure extraction, that comprises at least one of foam, crema, a sweetener and oil.

Beverage processing unit 5 may be configured to be fed with a liquid, e.g. water, supplied via a machine fluid line from a liquid source, e.g. a machine tank 6 or connector to an external liquid supply line, for instance via a machine pump and/or a thermal conditioner, e.g. a heater and/or cooler.

Beverage processing unit 5 may be configured to be fed with a flavouring ingredient, e.g. supplied into beverage processing unit 5 for instance within a capsule or loosely or as an agglomerate or in bulk, e.g. supplied as a particulate ingredient.

1: A machine for dispensing a beverage, wherein the machine comprises a beverage processing unit and a beverage outlet in fluid communication with the beverage processing unit, the beverage outlet having:
a collection cavity delimited by a bottom and a sidewall which are configured to collect the beverage from the beverage processing unit;
a bottom dispensing opening or edge configured to dispense the beverage from the beverage outlet to an area for placing a user-recipient to collect the dispensed beverage; and
a beverage transfer channel that fluidically connects the collection cavity to the bottom dispensing opening or edge and that is configured to guide the beverage between the collection cavity and the bottom dispensing opening or edge,
wherein the beverage transfer channel extends along a direction of flow in the beverage transfer channel from the collection cavity around at least part of the sidewall of the collection cavity to the bottom dispensing opening or edge.

2: The machine of claim 1, wherein the collection cavity has:
a maximum width;
a maximum length that is greater than the maximum width; and
a maximum depth,
the beverage transfer channel having a length along the direction of flow from the collection cavity to the bottom dispensing opening or edge that is greater than the maximum width and/or the maximum length of the collection cavity.

3: The machine of claim 1, wherein the beverage transfer channel extends along the direction of flow from the collection cavity around at least 20% of a total length of the sidewall.

4: The machine of claim 1, wherein the sidewall surrounds the collection cavity to extend from one side to an opposite side of the beverage transfer channel.

5: The machine of claim 1, wherein the beverage transfer channel has one side that is substantially delimited by the sidewall which extends between the collection cavity and the beverage transfer channel.

6: The machine of claim 1, wherein the beverage transfer channel and the collection cavity are connected by a passage having a width perpendicular to the direction of flow that is equal to a corresponding width of the beverage transfer channel or that is narrower than the beverage transfer channel width to slow down a flow of the beverage out of the collection cavity and/or prevent a flow of large beverage bubbles out of the collection cavity.

7: The machine of claim 1, wherein the beverage transfer channel in a beverage preparation orientation has an outlet conduit that extends along an upright flow direction and having a lower conduit part with a bottom end, the bottom dispensing opening or edge located at the bottom end of the lower conduit part of the outlet conduit.

8: The machine of claim 7, wherein, above the bottom end, the lower conduit part has a single lateral dispensing opening that is configured to dispense the beverage above the bottom dispensing opening or edge from the lower conduit part to the said area for placing the user-recipient when the bottom dispensing opening or edge is partly or fully obstructed at the bottom end.

9: The machine of claim 7, wherein the lower conduit part is associated with an inner flow guide.

10: The machine of claim 9, wherein the inner flow guide is configured to:
A) be shaped substantially as ribs or bars or upright walls;
B) be connected at a central part of the bottom end;
C) be spaced apart from a central part of the bottom end;
D) be non-intercepting each other;
E) extend substantially radially relative to a central axis of the lower conduit part; or
F) a combination of two or more of features A) to E).

11: The machine of claim 1, wherein the beverage processing unit has a beverage guide and a guide outflow opening via which the beverage is passed to the beverage outlet from the beverage guide.

12: The machine of claim 11, wherein the beverage outlet has an inflow penetrator for penetrating a flow of the beverage delivered by the guide outflow opening onto the penetrator prior to reaching the bottom of the collection cavity.

13: The machine of claim 12, wherein the inflow penetrator has one or more of the following features:
an upright generally spear-shaped member;
a top that extends into the guide outflow opening; and
a tapered top that extends from a cylindrical or prismatic penetrator bottom.

14: The machine of claim 1, wherein the beverage processing unit is configured to supply the beverage to the beverage outlet.

15: The machine of claim 14, wherein the beverage processing unit is configured to be fed with:
a liquid supplied via a machine fluid line from a liquid source; and/or
a flavouring ingredient supplied into the beverage processing unit.

16: The machine of claim 1, wherein the beverage outlet is configured to accumulate a pool of the beverage in the collection cavity.

17: The machine of claim 1, wherein the beverage outlet and/or the beverage processing unit is located at least partly in a stationary frame and/or housing.

18: The machine of claim 17, wherein the beverage outlet is movable relative to the stationary frame and/or housing between (i) a dispensing position in which the beverage outlet dispenses the beverage via the bottom dispensing opening or edge to the area for placing the user-recipient and (ii) a non-dispensing position in which the beverage outlet prevents dispensing via the bottom dispensing opening or edge to the area for placing the user-recipient.

19: The machine of claim 1, wherein the processing unit has a first part and a second part that are relatively movable between (a) a proximate configuration in which the first and second parts delimit a chamber for containing and processing a beverage ingredient therein and (b) a distant configuration for receiving the beverage ingredient in the chamber and/or evacuating the beverage ingredient from the chamber.
